(19) United States
(12) Patent Application Publication
(10) Pub. No.: US 2015/0370082 A1
(43) Pub. Date: Dec. 24, 2015

(54) SIMPLE STEREOSCOPE FOR ALLOWING SIDE-BY-SIDE IMAGE TO BE SEEN AS THREE-DIMENSIONAL IMAGE

(71) Applicant: GO4D TECHNOLOGY LLC., Coral Gables, FL (US)

(72) Inventor: Jae Hyuk CHOI, Yongin-si, Gyeonggi-do (KR)

(21) Appl. No.: 14/766,919

(22) PCT Filed: Feb. 12, 2014
(86) PCT No.: PCT/KR2014/001151

§ 371 Date: Aug. 10, 2015

(30) Foreign Application Priority Data
Feb. 14, 2013 (KR) 20-2013-0001123
Jun. 13, 2013 (KR) 10-2013-0068042

(51) Int. Cl. G02B 27/22

(52) U.S. Cl. CPC G02B 27/2228

(57) ABSTRACT

A simple stereoscope for viewing a side-by-side image is disclosed. The stereoscope (10, 100) comprises lens height-adjusting parts (30) for holding a first lens part and a second lens part such that the vertical heights of a first lens and a second lens can be adjusted within the range from a first height to a second height while the first lens and the second lens are placed side to side so as to be parallel with a horizontal direction. Furthermore, the stereoscope can further comprise lens interval-adjusting parts (50, 150) capable of adjusting horizontal intervals between the center of the first lens and the center of the second lens within a predetermined range. The stereoscope can also be formed by comprising an eyeglass frame and eyeglass temples and allowing a horizontal diameter of a lens mounting part of the eyeglass frame to be larger than that of the lenses so as to adjust the horizontal intervals of the two lenses.

### TECHNICAL FIELD

The present invention relates to a stereoscope used as a tool for viewing a three-dimensional image and, more specifically, to a simple stereoscope for allowing side-by-side stereo images to be shown as a three-dimensional image.

### BACKGROUND ART

When a person observes an object with his/her eyes, images of the same object that are viewed at slightly different angles while the left and right eyes are separated from each other are focused on the retinas of both the eyeballs and then transferred to the brain. The person's brain then composites the two received images and recognizes the perspective of stereoscopic space. Recently, three-dimensional images have been increasingly produced and consumed due to the attraction thereof. One of the conventional methods for enabling a person to view a three-dimensional image is to represent the same object as two images with a slight view-angle deviation and then enable the two images to be shown to a person's two eyes, respectively, as the principle that a person feels a three-dimensional sense with his/her two eyes. In order to view the stereo images as a three-dimensional image, taken through such a side-by-side method, a suitable stereoscope has to be used.

Among the many stereoscopes that exist, a simple stereoscope has been used, which is placed above side-by-side images in order to enable the person to view the images in three dimensions. FIG. 1 illustrates a representative example of a conventional pocket stereoscope 1. The pocket stereoscope 1 has a structure in which two lenses 2 are mounted in two lens holes that are spaced at a predetermined distance apart from each other on the left and right sides of a lens mounting plate 3, and four legs 4 with the same length extend downwards from the left and right ends of the lens mounting plate 3.

The pocket stereoscope 1 has a structural feature of which the separation distance between an object 5, which is to be viewed as a three-dimensional image, and the two lenses 2, and the interval between the two lenses 2 are fixed so that the user cannot adjust the separation distance and the interval. In general, the separation distance between the object 5 and the lenses 2 is preferably in a range of about 50 to 100 mm. However, since people have different eyesight characteristics (focal lengths), the optimal value of the separation distance may vary with the eyesight characteristics. If the separation distance cannot be adjusted, people may view the object 5 in a defocused state. Further, according to statistical data, the intervals between people's eyes vary with age, gender, race, and the like. Statistical data shows that: the interval between two eyes increases by up to 40 to 50 mm by the time children become adults; the average interval between eyes is about 55 mm in the case of adult females and about 65 mm in the case of adult males; and Caucasians have an interval that is 2 to 3 mm narrower than that of Negroids and Mongoloids. In cases where the interval between the two lenses 2 cannot be adjusted, many kinds of products that have different lens intervals have to be manufactured. Furthermore, since a user usually does not know the interval between his/her eyes, the user has to wear several products himself/herself and then select a product suitable for the interval between his/her eyes among the products available.

Meanwhile, in recent years, it has become popular to view photos or videos on smart phones. More photo or video content has been produced to be viewed in three dimensions (3D). Such photo or video content can be viewed in 3D by rendering the photo or video content in the form of a side-by-side stereo image on the screen of a smart phone and viewing the rendered screen using a stereoscope. In order to view such a three-dimensional image, a stereoscope optimized for the smart phone is required.

### DETAILED DESCRIPTION OF THE INVENTION

### Technical Problem

An object of the present invention is to provide a stereoscope that is configured to adjust the separation distance between two lenses and a smart-phone screen according to a user's focal length characteristic.

Another object of the present invention is to provide a stereoscope configured to adjust the interval between two lenses according to the interval between a user's eyes.

Yet another object of the present invention is to provide a stereoscope optimized for viewing side-by-side stereo images, displayed on a screen of a smart phone, in three dimensions.

### Technical Solution

In accordance with the present invention to accomplish the objects, a stereoscope includes: a first lens; a second lens; a lens frame for holding the first and second lenses so as to be parallel to each other on the left and right sides thereof; a lens temple that has one side coupled to a portable image reproduction device and an opposite side coupled to the lens frame and supports the first and second lenses so as to be spaced a predetermined distance apart from a screen of the portable image reproduction device; and an interval adjusting means for varying at least one of (i) the horizontal interval between the first and second lenses (hereinafter, referred to as the ‘inter-lens distance’) and (ii) the height of the first and second lenses from the screen of the portable image reproduction device (hereinafter, referred to as the ‘heights of the lens with respect to the screen’), wherein the stereoscope enables images that are reproduced in a side-by-side form on the screen of the portable image reproduction device to be shown as a three-dimensional image through the first and second lenses.

According to an embodiment, the interval adjusting means may include a lens height adjusting part for holding the lens frame to adjust the ‘heights of the lens with respect to the screen’ in a range of a first height to a second height. The lens height adjusting part may include: a first height adjusting bar vertically extending downwards at a predetermined distance from a one-side edge of the lens frame; a second height adjusting bar vertically extending downwards at a predetermined distance from an opposite-side edge of the lens frame; and first and second guide parts spaced a predetermined distance apart from each other on the left and right sides of the lens temple and engaged with the first and second height adjusting bars to guide the first and second height adjusting bars to slide in the vertical direction.

The lens height adjusting part may be preferably configured to adjust the ‘heights of the lens with respect to the screen’ to a desired value in the range of 55 to 65 mm by sliding the first and second height adjusting bars relative to the first and second guide parts.

According to an exemplary embodiment, the stereoscope may further include a support member for supporting the lens temple to maintain the lens temple in an upright state. In addition, the stereoscope may further include a push member for holding the portable image reproduction device seated on the support member while pressing the portable image reproduction device toward the support member.

According to another exemplary embodiment, the stereoscope may further include an insertion support member that extends rearwards from the lower portion of the rear surface of the lens temple, which is constituted with a plate member, in the horizontal direction, extends downwards at a predetermined distance in the vertical direction, and then extends toward the front side of the lens temple in the horizontal direction, wherein the insertion support member may hold the portable image reproduction device such that the screen of the portable image reproduction device is parallel to the first and second lenses when one side edge of the portable image reproduction device is inserted between the insertion support member and the bottom of the lens temple.

The interval adjusting means may preferably include a lens interval adjusting part that couples the first lens frame to the first height adjusting bar so as to be horizontally slid relative to the first height adjusting bar, and couples the second lens frame to the second height adjusting bar so as to be horizontally slid relative to the second height adjusting bar such that the ‘inter-lens distance’ is adjusted in a predetermined range. In this case, the lens frame may include a first lens frame that surrounds the first lens and a second lens frame that surrounds the second lens and is separated from the first lens frame.

The lens interval adjusting part may preferably adjust the horizontal interval between the centers of the first and second lenses in the range of 40 to 70 mm.

According to another exemplary embodiment, the stereoscope may further include a holding part connected to the distal end of the lens temple to hold the portable image reproduction device while partially surrounding two portions of the body thereof.

According to another exemplary embodiment, the interval adjusting means may include a lens interval adjusting part that adjusts the horizontal interval between the centers of the first and second lenses in a predetermined range. Furthermore, the lens interval adjusting part may include first and second lens mounting holes formed to be parallel to each other on the left and right sides of the lens frame, and first and second lens rims that surround the peripheries of the first and second lenses, respectively. The first and second lens mounting holes may have horizontal diameters larger than those of the first and second lens rims such that the first and second lens rims are horizontally moved by an external force while being press-fitted into the first and second lens mounting holes, whereby the ‘inter-lens distance’ may be adjusted.

In the lens interval adjusting part, a plurality of stopping recesses may be horizontally formed in a line on the inner upper and lower surfaces of the first and second lens mounting holes, stopping protrusions may be formed on the outer upper and lower surfaces of the first and second lens rims, and the ‘inter-lens distance’ may be adjusted according to which of the plurality of stopping recesses stops the stopping protrusions.

The lens temple may be preferably configured to be folded by a hinge part to reduce the volume thereof, wherein the hinge part may be provided at a location spaced a short distance apart from the lens frame in a perpendicular direction thereto.

### ADVANTAGEOUS EFFECTS

Thanks to a structure that can vary the vertical separation distance of two lenses with respect to an object to be viewed in 3D, users can adjust the vertical separation distance according to the focal lengths of their eyes. When the two lenses are separated at an optimal separation distance from the object to be viewed, the object can be most clearly shown. Accordingly, even if any user uses the stereoscope of the present invention, the stereoscope can enable the user to optimally adjust a customized focal length suitable for his/her eye characteristic, so that the user can view a clear three-dimensional image.

As mentioned above, intervals between people's eyes are different from each other. However, the stereoscope proposed by the present invention has a structure in which the horizontal separation distance between two lenses can be varied, so that even if any user uses the stereoscope, the user can adjust the interval between the two lenses according to the interval between his/her eyes. Furthermore, thanks to such an interval adjusting structure, it is unnecessary to manufacture various kinds of stereoscopes having different lens intervals, thereby reducing manufacturing costs. Since users can view three-dimensional images while the interval between the two lenses is accurately adjusted to be suitable for the intervals between their eyes, the users' eyes can be made less tired, the users do not find it inconvenient to view the images, and the users can view high quality images.

In addition, since the stereoscope of the present invention is optimally designed to be suitable for recently released smart phones, users can conveniently view side-by-side stereo images on the smart phones in three dimensions.

### BRIEF DESCRIPTION OF THE DRAWINGS

FIG. 1 illustrates the typical structure of a conventional stereoscope;

FIGS. 2 to 4 are an assembled perspective view, an exploded perspective view, and a side view, respectively, which illustrate the structure of a stereoscope according to a first embodiment of the present invention;

FIGS. 5 to 7 are an assembled perspective view, an exploded perspective view, and a side view, respectively, which illustrate the structure of a stereoscope according to a second embodiment of the present invention; and

FIGS. 8 to 12 are views illustrating the structure of a stereoscope according to a third embodiment of the present invention, wherein FIG. 8 is an assembled perspective view illustrating the structure of the stereoscope, FIG. 9 is a view illustrating a state in which eyeglass temples are folded, FIG. 10 is a view illustrating a state in which the stereoscope is mounted on an image reproduction device such as a smart phone, FIG. 11 is a perspective view illustrating a state in which two lenses are disassembled, and FIG. 12 (a) and (b) are views illustrating states in which the interval between the two lenses is adjusted to the maximum distance and the minimum distance.

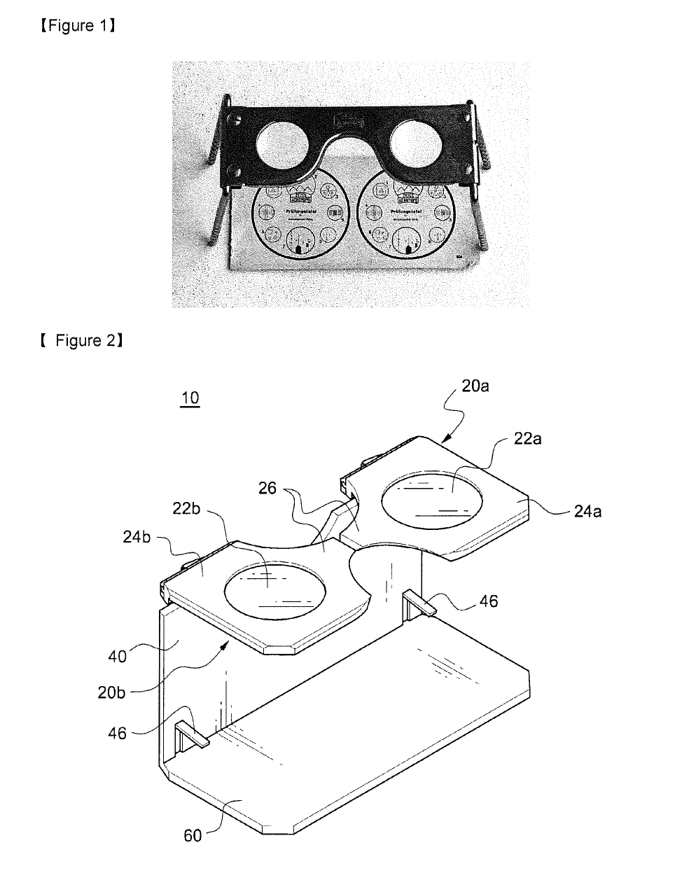

### MODE FOR CARRYING OUT THE INVENTION

Hereinafter, exemplary embodiments of the present invention will be described in detail with reference to the accompanying drawings.

### (1) First Embodiment

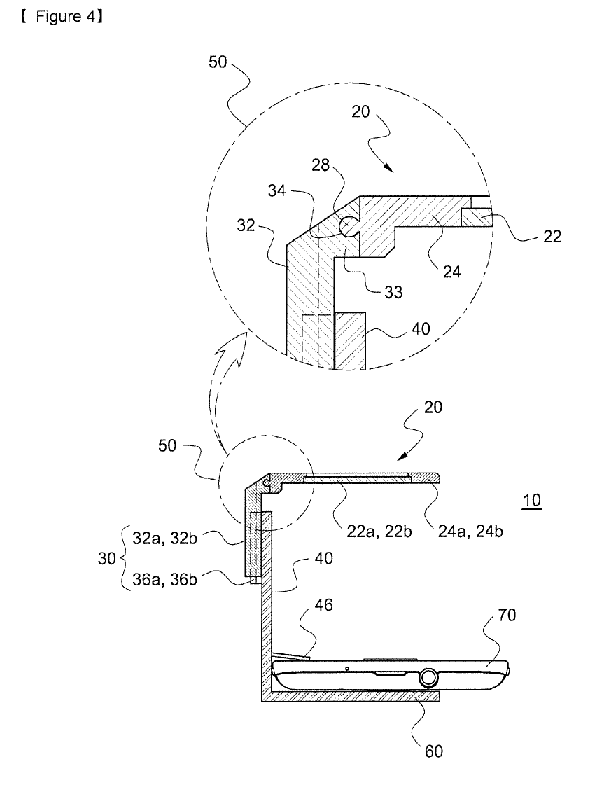

FIGS. 2 to 4 illustrate a stereoscope 10 according to a first embodiment of the present invention. The stereoscope 10 has a lens height adjusting part 30. The lens height adjusting part 30 includes two guide parts 36a and 36b that have the same structure and are mounted on the left and right sides of the rear surface of a vertical support member 40 in the shape of a plate. Each guide part 36a or 36b has a structure in which two guide bars vertically extending to be parallel to each other are spaced a predetermined distance apart from each other in the horizontal direction and secured to the rear surface of the vertical support member 40. Each guide part 36a or 36b provides a liner guide groove in the vertical direction.

First and second height adjusting bars 32a and 32b are inserted into the guide grooves of the two guide parts 36a and 36b, respectively, so as to slide in the vertical direction. The height adjusting bars 32a and 32b are used to adjust the vertical height of first and/or second lens part 20a or 20b to a desired height while being slid, by a user, along the guide grooves of the guide parts 36a and 36b in the vertical direction.

When photos or videos are present or displayed in the form of a side-by-side stereo on the screen of a smart phone 70, the distance between two lenses 22a and 22b and the screen of the smart phone 70 placed thereunder is preferably in the range of about 55 to 65 mm, as mentioned above, in consideration of a deviation in focal length of people's eyes in order for the people to view the photos or videos as a clear three-dimensional image through the two lenses 22a and 22b. That is, the vertical heights of the two lenses 22a and 22b should be able to be varied up to at least 10 mm. In order words, the first and second height adjusting bars 32a and 32b are preferably configured to slide ±5 mm or more along the first and second guide parts 36a and 36b in the vertical direction. The lengths of the height adjusting bars 32a and 32b and the guide parts 36a and 36b need to be longer than the desired vertical height adjustment range of the first and second lens parts 20a and 20b to reflect such a requirement.

The vertical support member 40 in the plate shape needs to be made in a self-standing structure, or needs to stand upright with the assistance of an auxiliary member. To this end, the stereoscope 10 preferably further includes, for example, a plate shape of support member 60 horizontally extending forwards at a predetermined distance from the lower edge of the vertical support member 40. Since the support member 60 and the vertical support member 40 are integrally connected to each other to form a right angle, the vertical support member 40 is maintained in an upright state with the assistance of the support member 60.

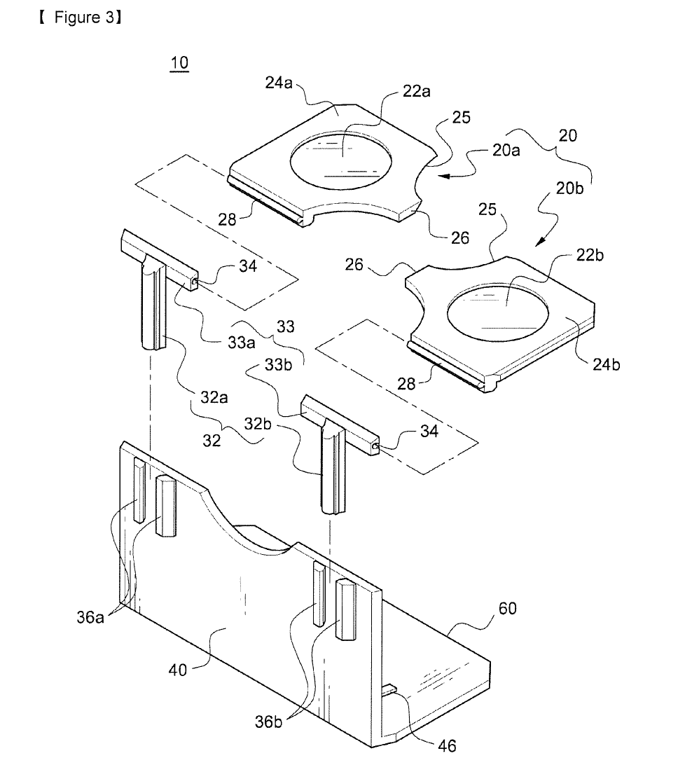

In addition, the stereoscope 10 has a lens part 20 that includes the first and second lens parts 20a and 20b. The first lens part 20a includes the first lens 22a and a first lens frame 24a that holds the first lens 22a while surrounding the periphery of the first lens 22a. The first lens frame 24a has a shape in which a front corner 25 thereof is roundly cut away. The rounded corner is for providing a space where a user's nose is inserted. The rear edge of the first lens frame 24a is coupled to the upper end of the first height adjusting bar 32a so that the first lens part 20a clings to the top of the first height adjusting bar 32a. Although the first lens frame 24a may be coupled to the first height adjusting bar 32a so as not to move relative thereto, the first lens frame 24a is preferably coupled to the first height adjusting bar 32a through a lens interval adjusting part 50 to slide relative thereto in the horizontal direction. For example, as illustrated in FIG. 3, the first lens frame 24a has a protrusion 28 horizontally protruding from the rear edge thereof, and the first height adjusting bar 32a has a guide member 33a on the upper end thereof, which corresponds to the protrusion 28. The guide member 33a has a guide groove 34 formed on the surface thereof facing the protrusion 28. The guide groove 34 holds the protrusion 28 to prevent the protrusion 28 from being separated therefrom after being inserted thereinto at the side of the guide groove in the horizontal direction, and guides the protrusion 28 to slide in the horizontal direction. The structure of the lens interval adjusting part 50, constituted with the protrusion 28 and the guide groove 34, provides a mechanism by which the first lens frame 24a may slide relative to the first height adjusting bar 32a in the horizontal direction.

The second lens part 20b is the same as the first lens part 20a with the exception of a second lens frame 24b that is axially symmetric to the first lens frame 24a. Accordingly, the second lens part 20b is coupled to the upper end of the second height adjusting bar 32b to cling thereto. The second lens part 20b is coupled to the second height adjusting bar 32b so as not to move relative thereto, or so as to slide relative thereto in the horizontal direction.

Both the horizontal sliding structure between the first lens frame 24a and the first height adjusting bar 32a and the horizontal sliding structure between the second lens frame 24b and the second height adjusting bar 32b may be adopted, or either of them may be adopted. The horizontal interval between the first and second lenses 22a and 22b (referred to as an ‘inter-lens distance’) may be adjusted by at least one of the two horizontal sliding structures. The horizontal interval between the centers of the first and second lenses 22a and 22b may be preferably adjusted to a desired value within the range of at least 40 to 70 mm by the lens interval adjusting part 50.

Protrusions 26 are formed on two edges of the two lens frames 24a and 24b facing each other, respectively, and the dimensions of the two lens frames 24a and 24b and the two protrusions 26 are preferably determined such that the horizontal interval between the centers of the first and second lenses 22a and 22b is 40 mm when the protrusions 26 of the two lens frames 24a and 24b make contact with each other.

Furthermore, the stereoscope 10 may also further include push members 46 that hold the smart phone 70 by pushing the smart phone 70 toward the support member 60 so as to prevent the smart phone 70 from freely moving when seated on the support member 60. The push members 46 are provided on the left and right sides of the vertical support member 40 and are preferably constituted with a resilient member.

### (2) Second Embodiment

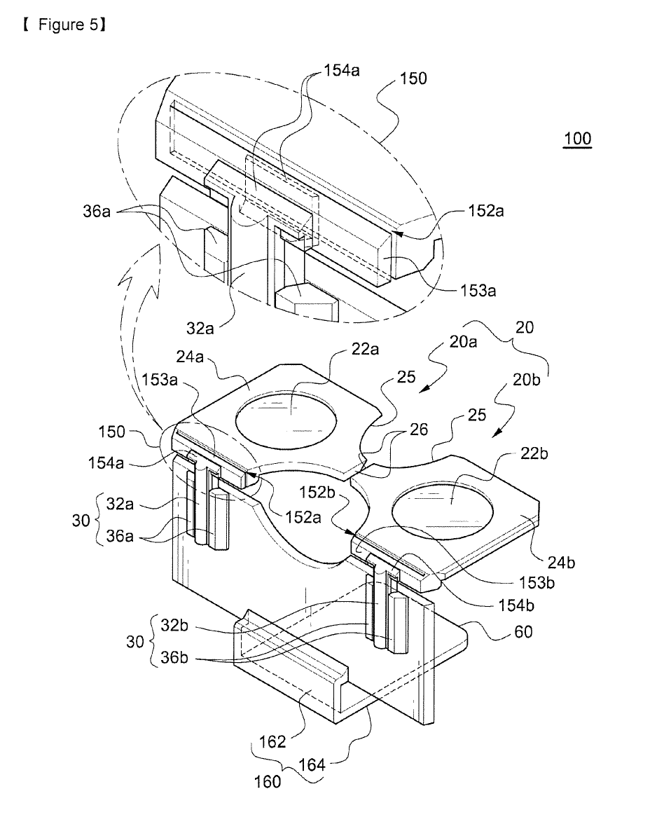

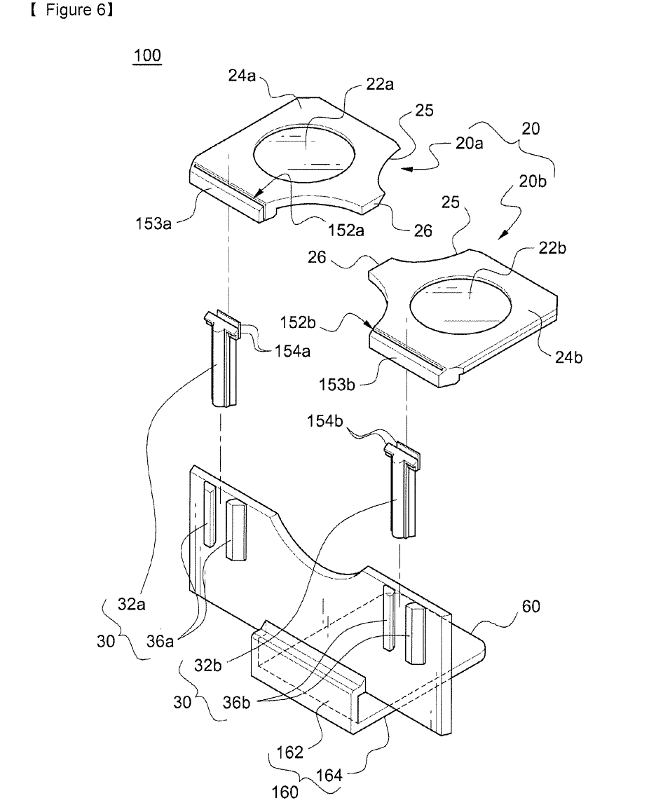

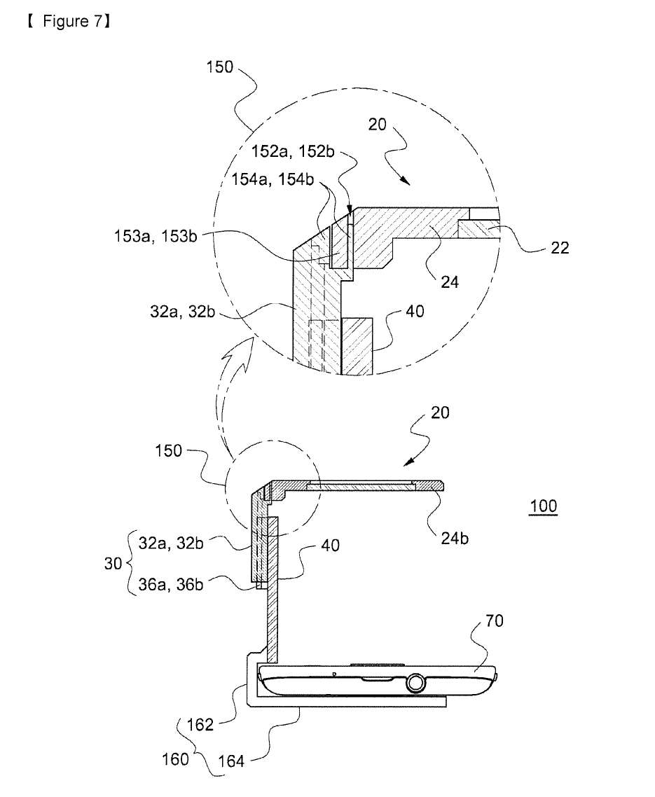

FIGS. 5 to 7 illustrate a stereoscope 100 according to a second embodiment of the present invention. The stereoscope 100 is the same as the stereoscope 10 of the first embodiment except elements constituting a lens interval adjusting part and a structure for holding a smart phone 70.

The structure of the lens interval adjusting part 150 of the stereoscope 100 is as follows. Openings 152a and 152b that have a predetermined width are vertically formed through rear edge portions 153a and 153b of first and second lens frames 124a and 124b along the rear edges, respectively. U-shaped suspenders 154a and 154b are provided on the upper ends of first and second height adjusting bars 132a and 132b, respectively, to correspond to the openings 152a and 152b. When each one of vertical parts of the U-shaped suspenders 154a and 154b is inserted into the openings 152a and 152b, the rear edge portions 153a and 153b which define the openings 152a and 152b are inserted into the U-shaped suspenders 154a and 154b and seated thereon. In this way, the first and second lens frames 124a and 124b are coupled to the first and second height adjusting bars 132a and 132b to slide relative to each other in the horizontal direction. The openings 152a and 152b and the U-shaped suspenders 154a and 154b provide a lens interval adjusting mechanism for the stereoscope 100 in this manner. The lens interval adjusting mechanism may also adjust the horizontal interval between the centers of first and second lenses 22a and 22b in the range of at least 40 to 70 mm.

The stereoscope 100 includes an insertion support member 160 instead of the support member 60 of the stereoscope 10 according to the first embodiment. The insertion support member 160 is a plate structure bent in the shape of ‘ [symbol] ,’ and the upper inlet portion thereof is fixedly connected to the lower portion of the rear surface of a vertical support member 40. More specifically, the insertion support member 160 extends rearwards at a predetermined distance (an enough distance to hold an edge of the smart phone 70) from the lower portion of the rear surface of the plate-shaped vertical support member 40 in the horizontal direction, extends downwards at a predetermined distance (to be slightly longer than the thickness of the smart phone 70) in the vertical direction, and then extends toward the front side of the vertical support member 40, namely, toward lens parts 20a and 20b in the horizontal direction (horizontally extending portion). Accordingly, the [symbol] -shaped insertion support member 160 provides a space where one edge of the smart phone 70 may be inserted into the opening of the t-shaped structure. When the upper side edge portion of the smart phone 70 is inserted between the horizontally extending portion of the insertion support member 160 and the bottom of the vertical support member 40, the insertion support member 160 holds the smart phone 70 to make the screen of the smart phone 70 parallel to the first and second lens parts 20a and 20b.

A mechanism for adjusting the vertical heights of the first and second lens parts 20a and 20b of the stereoscope 100 is the same as that of the stereoscope 10 according to the first embodiment.

### (3) Third Embodiment

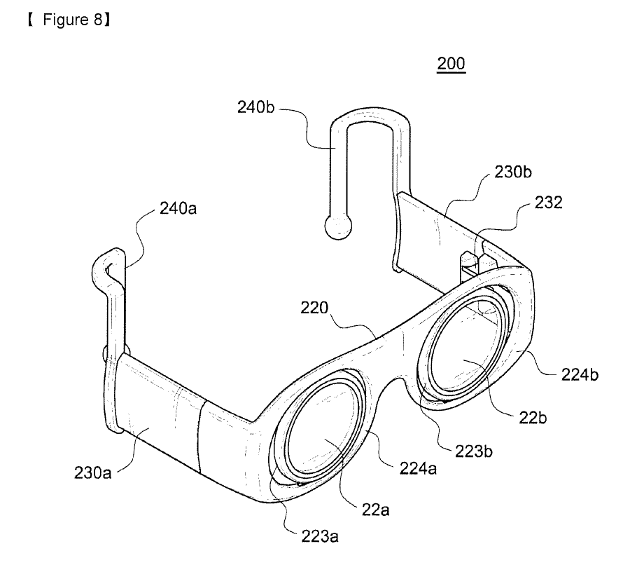

FIGS. 8 to 12 are: an assembled perspective view illustrating the structure of a stereoscope 200 according to a third embodiment of the present invention; a view illustrating a state in which eyeglass temples 230a and 230b are folded; a view illustrating a state in which the stereoscope is mounted on an image reproduction device 70 such as a smart phone; a perspective view illustrating a state in which two lenses 22a and 22b are disassembled; and a view illustrating states in which the interval between the two lenses 22a and 22b is adjusted to the maximum distance and the minimum distance, respectively.

The stereoscope 200, according to the third embodiment, differs from those according to the two aforementioned embodiments in that the overall shape of the stereoscope 200 is designed as an eyeglass shape, the left and right eyeglass temples 230a and 230b are foldable, the interval between the two lenses 22a and 22b can be adjusted, but the heights of the two lenses 22a and 22b from a screen of the image reproduction device 70 (e.g., a smart phone) cannot be adjusted.

More specifically, the stereoscope 200 includes: an eyeglass frame 220 that has first and second lens frames 224a and 224b on the left and right sides thereof and a nose support in the center thereof, wherein the first and second lens frames 224a and 224b are connected to each other and provides lens mounting holes; the first and second eyeglass temples 230a and 230b that are vertically bent from the left and right sides of the eyeglass frame 220 and extends a predetermined distance; and holding parts 240a and 240b connected to the distal ends of the first and second eyeglass temples 230a and 230b, respectively, to hold the image reproduction device 70 while partially surrounding two portions of the body thereof, and the overall structure of the stereoscope 200 is designed similar to an eyeglass shape.

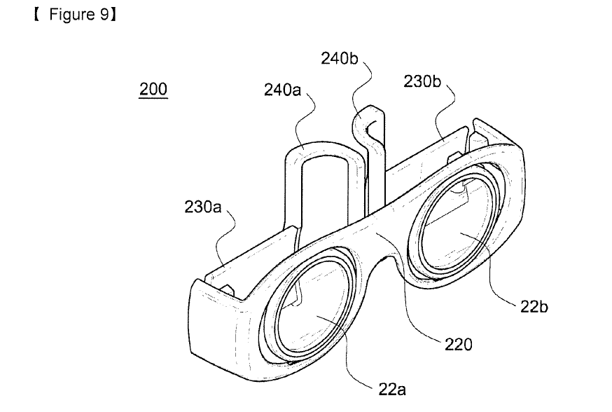

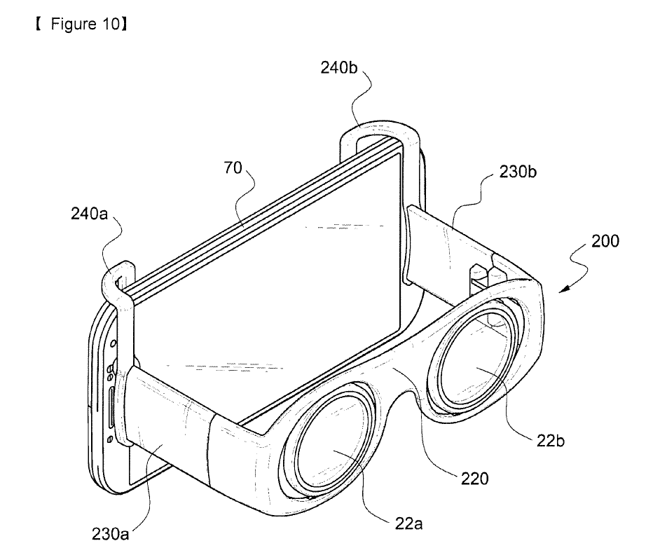

The first and second eyeglass temples 230a and 230b include hinge parts 232 at locations spaced a short distance apart from the lens frame 224 in a perpendicular direction thereto and may be folded by the hinge parts. While the stereoscope is not used, the first and second eyeglass temples 230a and 230b are folded by the hinge parts 232 as illustrated in FIG. 9 so that the total volume of the stereoscope can be reduced, thereby facilitating the storage of the stereoscope.

The holding parts 240a and 240b are designed in the shape of [symbol] and are preferably configured to hold the image reproduction device 70 received therein while pressing it by making the openings of the holding parts similar to or slightly smaller than the thickness of the image reproduction device 70. The holding parts 240a and 240b may have a gradually increasing section at the distal end thereof in order to prevent the image reproduction device 70 from being separated therefrom. FIG. 10 illustrates a state in which the stereoscope 200 is fastened to the body of the image reproduction device 70 by inserting the image reproduction device 70 into the holding parts 240a and 240b. When a user views images, which are reproduced in a side-by-side form on a screen of the image reproduction device 70, through the two lenses 22a and 22b in this state, the user can recognize the images as a three-dimensional image.

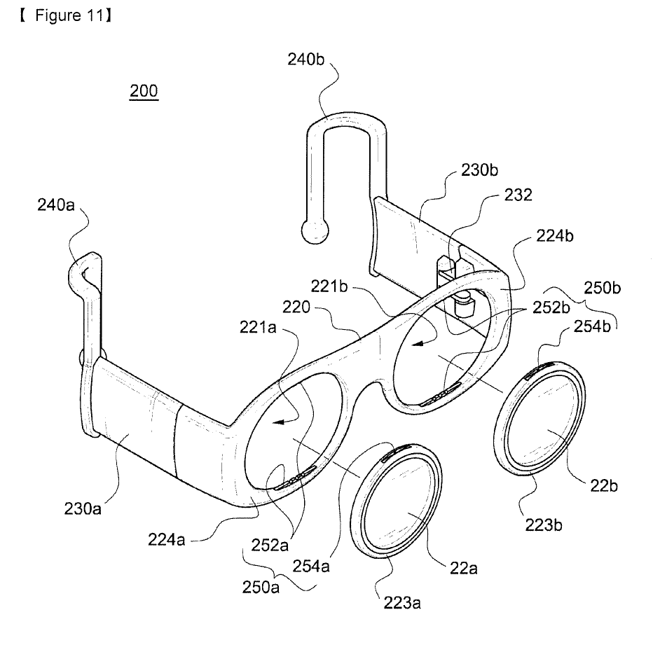

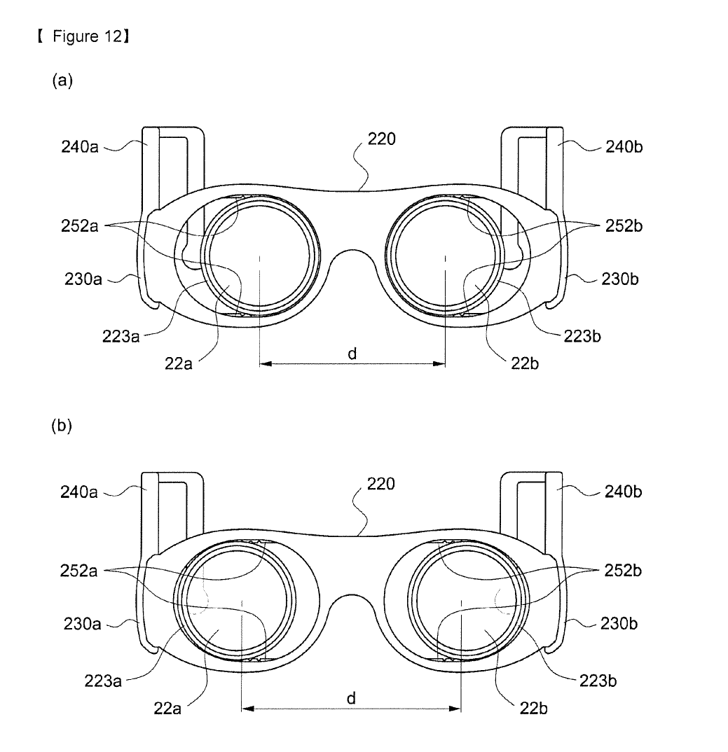

The first and second lens frames 224a and 224b have lens mounting holes 221a and 221b formed therein, respectively. The peripheries of the first and second lenses 22a and 22b are surrounded by lens rims 223a and 223b. Lens interval adjusting parts 250a and 250b are provided on the lens mounting holes 221a and 221b and the lens rims 223a and 223b. As illustrated in FIG. 11, the first lens interval adjusting part 250a includes a plurality of stopping recesses 252a horizontally formed in a line on the inner upper and lower surfaces of the first lens mounting hole 221a, and stopping protrusions 254a formed on the outer upper and lower surfaces of the first lens rim 223a. For example, three or more stopping recesses 252a are preferably formed. The structures of the lens rim 223b of the second lens 22b and the second lens mounting hole 221b, which constitute the second lens interval adjusting part 250b, are the same as those of the lens rim 223a of the first lens 22a and the first lens mounting hole 221a.

The vertical diameters of the first and second lens mounting holes 221a and 221b are a size that the lens rims can be press-fitted into the lens mounting holes, but the horizontal diameters are larger than those of the lens rims 223a and 223b. Accordingly, the first and second lens rims 223a and 223b may be press-fitted into the first and second lens mounting holes 221a and 221b, and may be horizontally moved by an external force. That is, when the first lens 22a is mounted in the first lens mounting hole 221a, the stopping protrusion 254a of the first lens rim 223a is inserted into one of the plurality of stopping recesses 252a and stopped thereby. The user may move the stopping protrusion 254a to another stopping recess 252a by applying a force to the first lens 22a in the horizontal direction. The same is true of the second lens 22b.

The horizontal interval between the two lenses 22a and 22b is determined according to the location where the two lenses 22a and 22b are stopped by the stopping recesses 252a and 252b. The user may apply a force to change the location where the stopping protrusion 254a of the first lens 22a is stopped by the stopping recess 252a and the location where the stopping protrusion 254b of the second lens 22b is stopped by the stopping recess 252b, thereby adjusting the horizontal interval between the two lenses 22a and 22b so as to be suitable for the interval between his/her eyes. FIG. 12 (a) illustrates a state in which the interval d between the two lenses 22a and 22b is largest, and FIG. 12 (b) illustrates a state in which the interval d between the two lenses 22a and 22b is smallest. The interval d between the two lenses 22a and 22b may be adjusted in the range of 40 to 70 mm as mentioned above.

The embodiments described above correspond only to exemplary embodiments of the present invention, and the above descriptions of the present invention correspond only to exemplary embodiments of the present invention. The present invention can be diversely modified and changed by those skilled in the art without departing from the spirit and scope of the present invention disclosed in the following patent claims. For example, the lens interval adjusting parts 50 and 150 may not be provided, and in this case, it may be advantageous in terms of manufacturing to integrally form the two lens frames 24a and 24b rather than to separate them. Furthermore, the lens frame, the vertical support member, the support member, the insertion support member, and the like may be designed in different shapes. In addition, it should be understood that the elements that constitute the lens height adjusting part 30 and the lens interval adjusting parts 50 and 150 can be implemented by adopting different things from those described above, which ensure the vertical and horizontal sliding of the lens parts. Therefore, all modifications pertaining to the meanings or ranges equivalent to the patent claims may fall within the scope of the present invention.

### INDUSTRIAL APPLICABILITY

Although the present invention may be mostly used to manufacture pocket stereoscopes, the present invention may be utilized to manufacture various stereoscopes for viewing side-by-side stereo still images or videos.

1. A stereoscope comprising:
a first lens;
a second lens;
a lens frame for holding the first and second lenses so as to be parallel to each other on the left and right sides thereof;
a lens temple that has one side coupled to a portable image reproduction device and an opposite side coupled to the lens frame and supports the first and second lenses so as to be spaced a predetermined distance apart from a screen of the portable image reproduction device; and
an interval adjusting means for varying at least one of (i) the horizontal interval between the first and second lenses (hereinafter, referred to as the ‘inter-lens distance’) and (ii) the heights of the first and second lenses from the screen of the portable image reproduction device (hereinafter, referred to as the ‘heights of the lens with respect to the screen’),
wherein the stereoscope enables images reproduced in a side-by-side form on the screen of the portable image reproduction device to be shown as a three-dimensional image through the first and second lenses.

2. The stereoscope of claim 1, wherein the interval adjusting means comprises a lens height adjusting part for holding the lens frame to adjust the ‘heights of the lens with respect to the screen’ in a range of a first height to a second height, and
the lens height adjusting part comprises: a first height adjusting bar vertically extending downwards at a predetermined distance from one-side edge of the lens frame; a second height adjusting bar vertically extending downwards at a predetermined distance from an opposite-side edge of the lens frame; and first and second guide parts spaced a predetermined distance apart from each other on the left and right sides of the lens temple and engaged with the first and second height adjusting bars to guide the first and second height adjusting bars to slide in the vertical direction.

3. The stereoscope of claim 2, wherein the lens height adjusting part adjusts the ‘heights of the lens with respect to the screen’ to a desired value in the range of 55 to 65 mm by sliding the first and second height adjusting bars relative to the first and second guide parts.

4. The stereoscope of claim 1, further comprising:
a support member for supporting the lens temple to maintain the lens temple in an upright state.

5. The stereoscope of claim 4, further comprising:
a push member for holding the portable image reproduction device seated on the support member while pressing the portable image reproduction device toward the support member.

6. The stereoscope of claim 1, further comprising:
an insertion support member that extends rearwards from the lower portion of the rear surface of the lens temple, which is constituted with a plate member, in the horizontal direction, extends downwards at a predetermined distance in the vertical direction, and then extends toward the front side of the lens temple in the horizontal direction, wherein the insertion support member holds the portable image reproduction device such that the screen of the portable image reproduction device is parallel to the first and second lenses when one side edge of the portable image reproduction device is inserted between the insertion support member and the bottom of the lens temple.

7. The stereoscope of claim 2, wherein the lens frame comprises a first lens frame that surrounds the first lens and a second lens frame that surrounds the second lens, and is separated from the first lens frame, and
the interval adjusting means comprises a lens interval adjusting part that couples the first lens frame to the first height adjusting bar so as to be horizontally slid relative to the first height adjusting bar and couples the second lens frame to the second height adjusting bar so as to be horizontally slid relative to the second height adjusting bar such that the ‘inter-lens distance’ is adjusted in a predetermined range.

8. The stereoscope of claim 1, wherein the interval adjusting means comprises a lens interval adjusting part that adjusts the horizontal interval between the centers of the first and second lenses in the range of 40 to 70 mm.

9. The stereoscope of claim 1, further comprising:
a holding part connected to the distal end of the lens temple to hold the portable image reproduction device while partially surrounding two portions of the body thereof.

10. The stereoscope of claim 1, wherein the interval adjusting means comprises a lens interval adjusting part that adjusts the horizontal interval between the centers of the first and second lenses in a predetermined range,
wherein the lens interval adjusting part comprises first and second lens mounting holes formed to be parallel to each other on the left and right sides of the lens frame, and first and second lens rims that surround the peripheries of the first and second lenses, respectively, and
the first and second lens mounting holes have horizontal diameters larger than those of the first and second lens rims such that the first and second lens rims are horizontally moved by an external force while being press-fitted into the first and second lens mounting holes whereby the ‘inter-lens distance’ is adjusted.

11. The stereoscope of claim 10, wherein a plurality of stopping recesses are horizontally formed in a line on the inner upper and lower surfaces of the first and second lens mounting holes, stopping protrusions are formed on the outer upper and lower surfaces of the first and second lens rims, and the ‘inter-lens distance’ is adjusted according to which of the plurality of stopping recesses stops the stopping protrusions.

12. The stereoscope of claim 1, wherein the lens temple is configured to be folded by a hinge part to reduce the volume thereof, the hinge part being provided at a location spaced a short distance apart from the lens frame in a perpendicular direction thereto.
